(19) United States
(12) Patent Application Publication
(10) Pub. No.: US 2026/0187337 A1
(43) Pub. Date: Jul. 2, 2026

(54) METHOD AND SYSTEM FOR OPTIMAL NAVIGATION OF UNSTRUCTURED DATA FOR LARGE LANGUAGE MODELS

(71) Applicant: Tata Consultancy Services Limited, Mumbai (IN)

(72) Inventors: Saurabh Rameshbhai BAGADIA, Ahmedabad (IN); Girish Vinayak PHADKE, Thane (IN)

(73) Assignee: Tata Consultancy Services Limited, Mumbai (IN)

(21) Appl. No.: 19/432,392

(22) Filed: Dec. 24, 2025

(30) Foreign Application Priority Data
Dec. 27, 2024 (IN) 202421103824

(51) Int. Cl. G06F 40/103; G06F 16/3332

(52) U.S. Cl. CPC G06F 40/103; G06F 16/3334

(57) ABSTRACT

Many service sectors deal with complex unstructured documents for making the customers understand and to make informed decisions or resolve issues. However, providing accurate and timely responses to customer queries on unstructured documents can be challenging. The present disclosure created a metadata schema that defines the structure and hierarchy of the unstructured document elements, such as headings and subheadings. Further, the present disclosure implemented parsing rules to ensure that all applicable documents metadata are captured despite inconsistencies in formatting. Furthermore, semantic preamble solution is used to understand the context and relationships between terms, which helps in accurately categorizing and segregating related content.

### PRIORITY CLAIM

This U.S. patent application claims priority under 35 U.S.C. § 119 to: Indian Patent Application number 202421103824 filed on Dec. 27, 2024. The entire contents of the aforementioned application are incorporated herein by reference.

### TECHNICAL FIELD

The disclosure herein generally relates to the field of machine learning and, more particularly, to a method and system for optimal navigation of unstructured data for large language models (LLMs).

### BACKGROUND

Many service sectors deal with complex unstructured documents for making the customers understand and to make informed decisions or resolve issues. However, providing accurate and timely responses to customer queries on unstructured documents can be challenging for the following reasons: 1. Complexity of Documents: Documents can be complex and difficult to understand. They often contain industry-specific jargon and terms that the average person may not be familiar with. 2. Issue-Driven Queries: Queries tend to be more issue-driven than the average sales query. Users often reach out at critical points in their journey, such as when they need to purchase a product, seek information to clarify their policy, need to update their account, or when they encounter a problem. 3. Response Time: Users expect quick responses to their queries. However, due to the complexity of some queries, it might take time to provide a comprehensive response. 4. Diverse Users Expectations: Users have diverse needs and expectations, which can be challenging to meet without a deep understanding of the customer.

AI-assisted bots that augment existing users service can help customers in the B2C (Business to Customer) value chain by providing quick and personalized responses to their inquiries. These bots can be programmed to understand the context of the user's query and provide relevant information or solutions. This can lead to increased customer satisfaction and loyalty, as well as reduced cost-to-serve for the company.

The integration of Large Language Models (LLMs) into various sectors has been transformative, with the Retrieval-Augmented Generation (RAG) architecture gaining traction for its ability to deliver precise responses to complex queries. The foundation of such models is their proficiency at processing and interpreting unstructured data to provide accurate and answers in natural language.

However, RAG design with LLM does not put emphasis on handling and transforming unstructured data. In a typical, RAG approach, contents are extracted from a given document without putting focus on schema and structure of a document. It works well with documents which are highly structured and consistent, however for documents which are unstructured and not consistent, deriving schema of a document becomes a very vital step. The current technology design and approach merely focuses on extracting data and saving data into appropriate data stores. This leads to a fundamental problem where result accuracy is of utmost importance. With normal RAG pattern like this, there is a possibility of results ambiguity, missing of important information and in turn results into low accurate results.

Further, the open source and Cloud Native tools mostly fail to correctly identify heading and subheadings from the unstructured documents. Headings and subheadings are crucial navigational markers in any documents, functioning much like a map to the segmented chunks of content. Existing methods hardly seem to focus on the above issue. Furthermore, there is a lack of approaches which can take care of addressing ambiguity between similar sub-sections.

### SUMMARY

Embodiments of the present disclosure present technological improvements as solutions to one or more of the above-mentioned technical problems recognized by the inventors in conventional systems. For example, in one embodiment, a method for optimal navigation of unstructured data for large language models is provided. The method includes receiving, via one or more hardware processors, a user request and an associated plurality of unstructured input documents, wherein the user request is in natural language. Further, the method includes extracting, via the one or more hardware processors, a plurality of request parameters based on the user request, wherein the request parameters comprises an industry name, a product name and domain contents. Furthermore, the method includes obtaining (206), via the one or more hardware processors, a master layout from among a plurality of domain based master layouts based on the plurality of request parameters, wherein the master layout comprises a schema and a plurality of document structure details, wherein each of the plurality of domain based master layout is generated by: (i) receiving a plurality of unstructured documents associated with each of a plurality of domains, wherein the plurality of domains comprises a healthcare domain, an insurance domain, a manufacturing domain, a contact center and a retail domain (ii) extracting a plurality of document parameters comprising a heading, a sub heading and a paragraph based on the plurality of unstructured documents associated with each of the plurality of domains using a document processing technique (iii) generating a schema for each of the plurality of unstructured documents associated with each of the plurality of domains based on an associated plurality of document parameters (iv) generating an aggregated schema layout for each of the plurality of domains by performing a union of a plurality of schemas associated with the plurality of unstructured documents associated with each of the plurality of domains and by assigning appropriate roles and (v) generating the domain based master layout for each of the plurality of domains based on an associated aggregated schema layout using a semantic preamble refined text generation technique, wherein the semantic preamble refined text generation technique replaces ambiguous text content with meaningful content. Furthermore, the method includes extracting via the one or more hardware processors, a plurality of text contents from each of the plurality of unstructured input documents using the document processing technique, wherein the plurality of text contents comprises a heading, a subheading and a paragraph. Furthermore, the method includes generating, via the one or more hardware processors, a plurality of data frames based on a comparison between the plurality of text contents extracted from the plurality of input documents and the schema in the associated master layout. Furthermore, the method includes generating, via the one or more hardware processors, a refined plurality of data frames by replacing a plurality of ambiguous text contents based on the schema in the associated domain based master layout. Furthermore, the method includes generating, via the one or more hardware processors, a plurality of data chunks based on the refined plurality of data frames. Furthermore, the method includes generating, via the one or more hardware processors, an associated vector embedding corresponding to each of the plurality of data chunks using a machine learning technique. Finally, the method includes generating, via the one or more hardware processors, a response corresponding to the user request based on the generated associated vector embedding using a Large Language Model (LLM).

In another aspect, a system for optimal navigation of unstructured data for large language models is provided. The system includes at least one memory storing programmed instructions, one or more Input/Output (I/O) interfaces, and one or more hardware processors operatively coupled to the at least one memory, wherein the one or more hardware processors are configured by the programmed instructions to receive a user request and an associated plurality of unstructured input documents, wherein the user request is in natural language. Further, the one or more hardware processors are configured by the programmed instructions to extract a plurality of request parameters based on the user request, wherein the request parameters comprises an industry name, a product name and domain contents. Furthermore, the one or more hardware processors are configured by the programmed instructions to obtain, via the one or more hardware processors, a master layout from among a plurality of domain based master layouts based on the plurality of request parameters, wherein the master layout comprises a schema and a plurality of document structure details, wherein each of the plurality of domain based master layout is generated by: (i) receiving a plurality of unstructured documents associated with each of a plurality of domains, wherein the plurality of domains comprises a healthcare domain, an insurance domain, a manufacturing domain, a contact center and a retail domain (ii) extracting a plurality of document parameters comprising a heading, a sub heading and a paragraph based on the plurality of unstructured documents associated with each of the plurality of domains using a document processing technique (iii) generating a schema for each of the plurality of unstructured documents associated with each of the plurality of domains based on an associated plurality of document parameters (iv) generating an aggregated schema layout for each of the plurality of domains by performing a union of a plurality of schemas associated with the plurality of unstructured documents associated with each of the plurality of domains and by assigning appropriate roles and (v) generating the domain based master layout for each of the plurality of domains based on an associated aggregated schema layout using a semantic preamble refined text generation technique, wherein the semantic preamble refined text generation technique replaces ambiguous text content with meaningful content. Furthermore, the one or more hardware processors are configured by the programmed instructions to extract a plurality of text contents from each of the plurality of unstructured input documents using the document processing technique, wherein the plurality of text contents comprises a heading, a subheading and a paragraph. Furthermore, the one or more hardware processors are configured by the programmed instructions to generate a plurality of data frames based on a comparison between the plurality of text contents extracted from the plurality of input documents and the schema in the associated master layout. Furthermore, the one or more hardware processors are configured by the programmed instructions to generate a refined plurality of data frames by replacing a plurality of ambiguous text contents based on the schema in the associated domain based master layout. Furthermore, the one or more hardware processors are configured by the programmed instructions to generate a plurality of data chunks based on the refined plurality of data frames. Furthermore, the one or more hardware processors are configured by the programmed instructions to generate an associated vector embedding corresponding to each of the plurality of data chunks using a machine learning technique. Finally, the one or more hardware processors are configured by the programmed instructions to generate a response corresponding to the user request based on the generated associated vector embedding using a Large Language Model (LLM).

In yet another aspect, a computer program product including a non-transitory computer-readable medium embodied therein a computer program for optimal navigation of unstructured data for large language models is provided. The computer readable program, when executed on a computing device, causes the computing device to receive a user request and an associated plurality of unstructured input documents, wherein the user request is in natural language. Further, the computer readable program, when executed on a computing device, causes the computing device to extract a plurality of request parameters based on the user request, wherein the request parameters comprises an industry name, a product name and domain contents. Furthermore, the computer readable program, when executed on a computing device, causes the computing device to obtain, a master layout from among a plurality of domain based master layouts based on the plurality of request parameters, wherein the master layout comprises a schema and a plurality of document structure details, wherein each of the plurality of domain based master layout is generated by: (i) receiving a plurality of unstructured documents associated with each of a plurality of domains, wherein the plurality of domains comprises a healthcare domain, an insurance domain, a manufacturing domain, a contact center and a retail domain (ii) extracting a plurality of document parameters comprising a heading, a sub heading and a paragraph based on the plurality of unstructured documents associated with each of the plurality of domains using a document processing technique (iii) generating a schema for each of the plurality of unstructured documents associated with each of the plurality of domains based on an associated plurality of document parameters (iv) generating an aggregated schema layout for each of the plurality of domains by performing a union of a plurality of schemas associated with the plurality of unstructured documents associated with each of the plurality of domains and by assigning appropriate roles and (v) generating the domain based master layout for each of the plurality of domains based on an associated aggregated schema layout using a semantic preamble refined text generation technique, wherein the semantic preamble refined text generation technique replaces ambiguous text content with meaningful content. Furthermore, the computer readable program, when executed on a computing device, causes the computing device to extract a plurality of text contents from each of the plurality of unstructured input documents using the document processing technique, wherein the plurality of text contents comprises a heading, a subheading and a paragraph. Furthermore, the computer readable program, when executed on a computing device, causes the computing device to generate a plurality of data frames based on a comparison between the plurality of text contents extracted from the plurality of input documents and the schema in the associated master layout. Furthermore, the computer readable program, when executed on a computing device, causes the computing device to generate a refined plurality of data frames by replacing a plurality of ambiguous text contents based on the schema in the associated domain based master layout. Furthermore, the computer readable program, when executed on a computing device, causes the computing device to generate a plurality of data chunks based on the refined plurality of data frames. Furthermore, the computer readable program, when executed on a computing device, causes the computing device to generate an associated vector embedding corresponding to each of the plurality of data chunks using a machine learning technique. Finally, the computer readable program, when executed on a computing device, causes the computing device to generate a response corresponding to the user request based on the generated associated vector embedding using a Large Language Model (LLM).

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1A is a functional block diagram of a system for optimal navigation of unstructured data for large language models, in accordance with some embodiments of the present disclosure.

FIG. 1B illustrates overall functional architecture of the system for the optimal navigation of unstructured data for large language models, in accordance with some embodiments of the present disclosure.

FIG. 2A and FIG. 2B (referred to as FIG. 2) illustrates a flow diagram for a processor implemented method for optimal navigation of unstructured data for large language models, in accordance with some embodiments of the present disclosure.

FIG. 3 illustrates a flow diagram for generating a domain based master layout for optimal navigation of unstructured data for large language models, in accordance with some embodiments of the present disclosure.

FIG. 4 illustrates a detailed flow diagram for the processor implemented method for optimal navigation of unstructured data for large language models, in accordance with some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments.

Study of unstructured documents to identify technical challenges in automatic content reading and interpretation brough out observations as listed below.

There were three main challenges with unstructured documents.

### 1. Inconsistency in Document Formatting:

A significant obstacle was the inconsistency in document formatting. A large set of documents were prepared manually making it very difficult for certain market tools (Open source as well Native tools) to distinguish between heading, subheading for such documents. For instance, a piece of text in one document might be recognized as a “Header,” while the same text in another document-positioned identically-could be misclassified as a “Sub-Heading.” Such discrepancies pose a considerable challenge for information extraction and structuring and hold back absolute automation. For example,
For CONNECTICUT, the role for domain content “Operational FAQ” section is detected as None. Paragraph (role=None, content=Operational FAQ.
For ALASKA, the role for domain content “Operational FAQ” section is detected as sectionHeading. Paragraph (role=sectionHeading, content=Operational FAQ.
For CONNECTICUT, Under SUPPLIER SECTION “Covered Policy” and “Exclusions” is detected as separate content Paragraph (role=sectionHeading, content=Covered Policy, Paragraph (role=sectionHeading, content=Exclusions.
For ALASKA, Under SUPPLIER SECTION, the section “Covered Policy” is detected as merged content (“Covered Policy Exclusions”) Paragraph (role=sectionHeading, content=Covered Policy Exclusions.
   2. Addressing Ambiguity from Similar Sub-section Headers: Another challenge was the presence of similar sub-section headers across various sections of documents, which introduced ambiguity into the system. This ambiguity made it difficult for an LLM to ascertain the precise section from which to extract information for a given query. For example, under different but closed related headings, there are common sub-headings called “Medical”. Medical sub-headings had their own text/paragraphs. Without applying any data engineering methodology, sometimes LLM was giving output from either of the sub-section and sometimes it was mixing up them. To simplify, sections with overlapping definitions were included, and it was needed to ensure that the system is flexible and scalable that it brings information from the correct sub-section and doesn't mix up them. This can be confusing for the system, which needs clear and distinct labels to avoid mixing up information from different sections. It's important to know exactly where information is in the documents.
For example, if looking at “Return Policies,” its needed to know whether it's under “Defective Items” or “Damaged Items.” This can be confusing for the system, which needs clear and distinct labels to avoid mixing up information from different sections.
Another example could be, a question about ‘Prescription Medications’ coverage under ‘Inpatient Care’, there's a chance it might also combine information from the ‘Prescription Medications’ coverage under ‘Outpatient Care’. This is because both sections share the same subsection and coverage types, which could lead to confusion without a refined data processing approach

### 3. Handling Loosely Related Semantic Terms:

A further complication in data engineering process is the presence of loosely related semantic terms within documents. Sub-sections often contained terms that were closely associated, which had the potential to confuse the system, leading to a mix-up of information extracted from disparate contexts. For example, if there are two sub-sections called “Extreme” and “Adventures” and each sub-sections had their own bulleted list. When user asked questions about the either of this term, the observation was that sometimes LLM mixed up response from both the sub-sections.
For example, System tries to group and extract text that's closely related. However, when terms are only loosely related, it can confuse the system and mix up the information from different contexts. For e.g.—Both words “Extreme” and “Adventure” are very closed and semantically carry the same meaning. When user was asking question about “Extreme” activities, LLM was sometimes combining responses from both “Extreme” and “Adventure” section.

The problem was identified through the observation of the document structure and the potential confusion caused by the lack of clear distinction between sections. The decision to solve this problem was driven by the need to improve the accuracy and relevance of the Search results and the responses provided by the Generative Pretrained Transformer model (GPT Models) to customer queries.

To address the technical complexity of machine analysis of the document, embodiments herein provide a method and system for optimal navigation of unstructured data for large language models. The present disclosure handles unstructured data during “Data Engineering” process of Large Language model. It aims to demonstrate improved accuracy and relevancy of search results by reducing overall turnaround time. The present disclosure identifies and resolves the ambiguity in document sections, and to clearly distinguish between document headings and subheadings. This is very important for navigating through a document and mapping its contents to the right headings and subheadings.

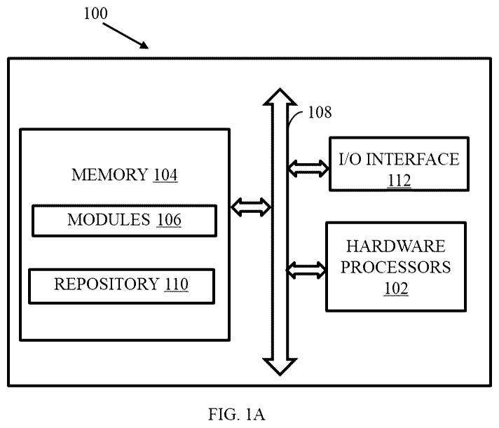

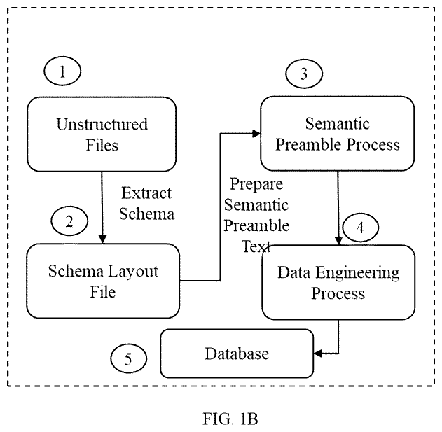

Referring now to the drawings, more particularly to FIG. 1A through FIG. 4, where similar reference characters denote corresponding features consistently throughout the figures, there are shown preferred embodiments, and these embodiments are described in the context of the following exemplary system and/or method.

FIG. 1A is a functional block diagram of system 100 for Optimal navigation of unstructured data for large language models, in accordance with some embodiments of the present disclosure. The system 100 includes or is otherwise in communication with hardware processors 102, at least one memory such as a memory 104, an Input/Output (I/O) interface 112. The hardware processors 102, memory 104, and the I/O interface 112 may be coupled by a system bus such as a system bus 108 or a similar mechanism. In an embodiment, the hardware processors 102 can be one or more hardware processors.

The I/O interface 112 may include a variety of software and hardware interfaces, for example, a web interface, a graphical user interface, and the like. The I/O interface 112 may include a variety of software and hardware interfaces, for example, interfaces for peripheral device(s), such as a keyboard, a mouse, an external memory, a printer and the like. Further, the I/O interface 112 may enable system 100 to communicate with other devices, such as web servers, and external databases.

The I/O interface 112 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface 112 may include one or more ports for connecting several computing systems with one another or to another server computer. The I/O interface 112 may include one or more ports for connecting several devices to one another or to another server.

The one or more hardware processors 102 may be implemented as one or more microprocessors, microcomputers, microcontrollers, digital signal processors, central processing units, node machines, logic circuitries, and/or any devices that manipulate signals based on operational instructions. Among other capabilities, the one or more hardware processors 102 is configured to fetch and execute computer-readable instructions stored in memory 104.

The memory 104 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, memory 104 includes a plurality of modules 106. Memory 104 also includes a data repository (or repository) 110 for storing data processed, received, and generated by the plurality of modules 106.

The plurality of modules 106 includes programs or coded instructions that supplement applications or functions performed by the system 100 for Optimal navigation of unstructured data for large language models. The plurality of modules 106, amongst other things, can include routines, programs, objects, components, and data structures, which perform particular tasks or implement particular abstract data types. The plurality of modules 106 may also be used as, signal processor(s), node machine(s), logic circuitries, and/or any other device or component that manipulates signals based on operational instructions. Further, the plurality of modules 106 can be used by hardware, by computer-readable instructions executed by the one or more hardware processors 102, or by a combination thereof. The plurality of modules 106 can include various sub-modules (not shown). The plurality of modules 106 may include computer-readable instructions that supplement applications or functions performed by the system 100 for Optimal navigation of unstructured data for large language models.

The data repository (or repository) 110 may include a plurality of abstracted pieces of code for refinement and data that is processed, received, or generated as a result of the execution of the plurality of modules in the module(s) 106.

Although the data repository 110 is shown internal to the system 100, it will be noted that, in alternate embodiments, the data repository 110 can also be implemented external to the system 100, where the data repository 110 may be stored within a database (repository 110) communicatively coupled to the system 100. The data contained within such an external database may be periodically updated. For example, new data may be added into the database (not shown in FIG. 1A) and/or existing data may be modified and/or non-useful data may be deleted from the database. In one example, the data may be stored in an external system, such as a Lightweight Directory Access Protocol (LDAP) directory, a Relational Database Management System (RDBMS).

The overall architecture of the system of FIG. 1A is explained in conjunction with FIG. 1B. Now referring to FIG. 1B, initially, unstructured files associated with a user query is received and schema is extracted. Further, a schema layout file is generated based on the extracted schema. Further, semantic preamble process is performed to remove ambiguity. Finally, data engineering process is performed on the ambiguity removed files to provide an answer to the user query. The data engineering process includes (i) extracting a plurality of text contents from a plurality of unstructured input documents using the document processing technique, wherein the plurality of text contents comprises a heading, a subheading and a paragraph (ii) generating a plurality of data frames based on a comparison between the plurality of text contents extracted from the plurality of input documents and the schema in the associated domain based master layout (iii) generating a refined plurality of data frames by replacing a plurality of ambiguous text contents based on the schema in the associated domain based master layout (iv) generating a plurality of data chunks based on the refined plurality of data frames (v) generating an associated vector embedding corresponding to each of the plurality of data chunks using a machine learning technique and (vi) generating a response corresponding to the user request based on the generated associated vector embedding using an Large Language Model (LLM).

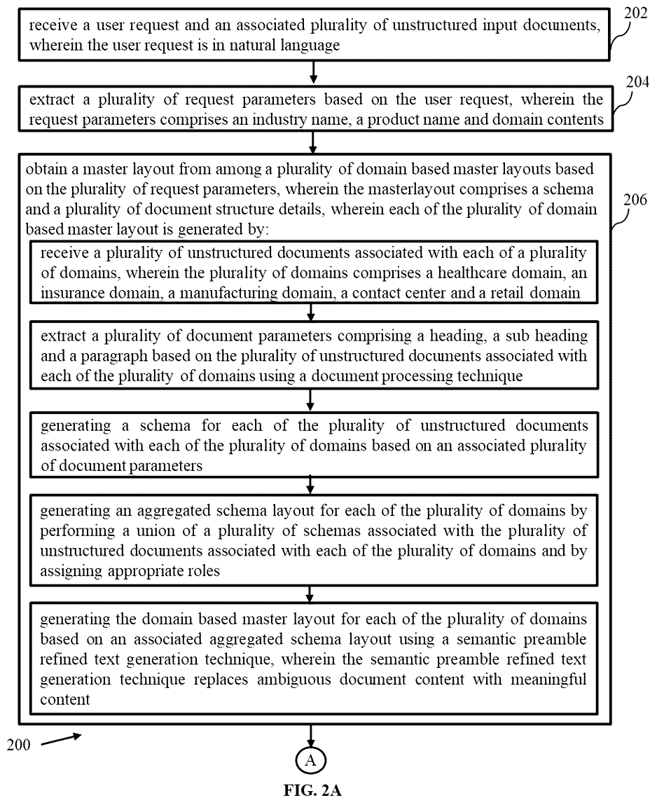

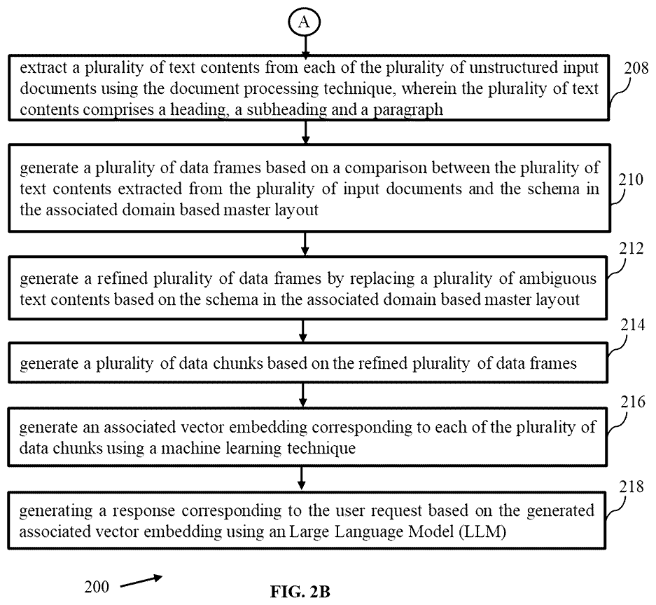

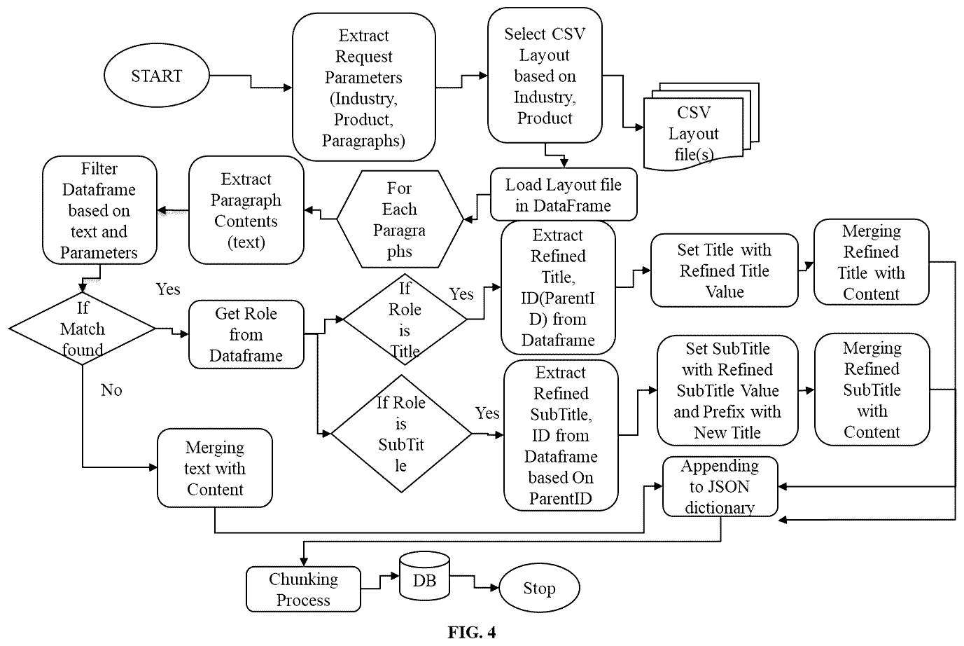

The working of the components of system 100 are explained with reference to the method steps depicted in FIG. 2 and the overall flow diagram shown in FIG. 4.

FIG. 2 is an exemplary flow diagram illustrating a method 200 for optimal navigation of unstructured data for large language models implemented by the system of FIGS. 1A and 1B, according to some embodiments of the present disclosure. In an embodiment, the system 100 includes one or more data storage devices or the memory 104 operatively coupled to the one or more hardware processor(s) 102 and is configured to store instructions for execution of steps of the method 200 by the one or more hardware processors 102. The steps of method 200 of the present disclosure will now be explained with reference to the components or blocks of system 100 as depicted in FIGS. 1A and 1B and the steps of flow diagram as depicted in FIG. 2. The method 200 may be described in the general context of computer executable instructions. Generally, computer executable instructions can include routines, programs, objects, components, data structures, procedures, modules, functions, etc., that perform particular functions or implement particular abstract data types.

The method 200 may also be practiced in a distributed computing environment where functions are performed by remote processing devices that are linked through a communication network. The order in which the method 200 is described is not intended to be construed as a limitation, and any number of the described method blocks can be combined in any order to implement the method 200, or an alternative method. Furthermore, the method 200 can be implemented in any suitable hardware, software, firmware, or combination thereof.

Now referring to FIG. 2, at step 202 of method 200, the one or more hardware processors 102 are configured by the programmed instructions to receive a user request and an associated plurality of unstructured input documents, wherein the user request is in natural language. For example, a user query can be “what is not included in my policy?”, “What is the payment terms in the contracts?”, “what is the policy to return damaged product”, “My Vacuum pump is not working, what could be a problem?”

At step 204 of the method 200, the one or more hardware processors 102 is configured by the programmed instructions to extract a plurality of request parameters based on the user request, wherein the request parameters comprises an industry name, a product name and domain contents. For example, considering the user query, “List down FAQs for international travel insurance policy”, the plurality of request parameters includes “industry=insurance”, “product=international insurance” and “domain content=List down FAQs for international travel insurance policy”.

At step 206 of the method 200, the one or more hardware processors 102 is configured by the programmed instructions to obtain a master layout from among a plurality of domain based master layouts based on the plurality of request parameters, wherein the master layout comprises a schema and a plurality of document structure details. Tables I and II illustrates an example master layout. For example, Tables I and II, maintains schema of an unstructured file. They also captures the domain contents such as heading and subheading of unstructured documents and provides semantic preamble meaning to each heading and subheading. Further, the Tables I and II captures the role of heading, subheading for a domain content to effectively tag them to a domain content during a data engineering processing and maintains hierarchical structure through which subheadings can be navigated under a heading.

TABLE I

| Fields | Purpose |
|---|---|
| Product | To maintain product name. |
| ID | Incremental ID value |
| Original Text | Original Text for heading and |
| | subheading |
| Semantic-Preamble | Refined Text for heading and |
| Text | subheading |
| Assigned Role | Role defined for Text |
| Parent ID | Parent ID in association with ID |

TABLE II

| | | Original | Semantic- | | |
|---|---|---|---|---|---|
| Product | ID | Text | Preamble Text | Assigned Role | Parent ID |
| Medical | 12 | Inpatient | This section | Title | NULL |
| | | Care | outlines critical | | |
| | | | guidelines for | | |
| | | | Inpatient care. | | |
| Medical | 15 | Coverage | Coverage details | SectionHeading | 12 |
| | | Details | related to | | |
| | | | Inpatient care are | | |
| | | | described in | | |
| | | | below section. | | |
| Medical | 20 | Outpatient | This section | Title | Null |
| | | Care | outlines critical | | |
| | | | guidelines for | | |
| | | | Outpatient care. | | |
| Medical | 26 | Coverage | Coverage details | SectionHeading | 20 |
| | | Details | related to | | |
| | | | Outpatient care | | |
| | | | are described in | | |
| | | | below section. | | |

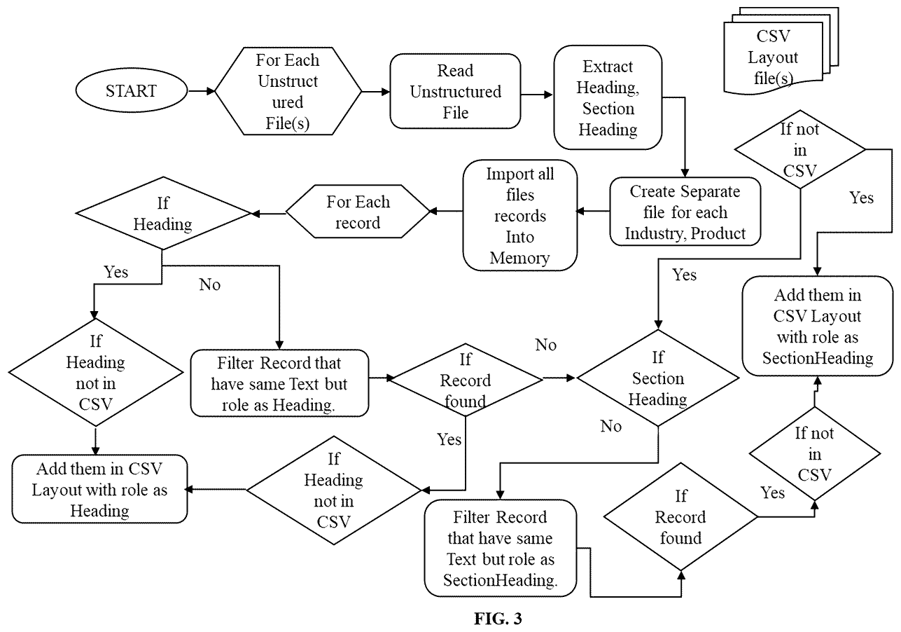

For example, the steps for generating domain based master layout is explained in conjunction with FIG. 3 as follows. Initially, a plurality of unstructured documents associated with each of a plurality of domains are received. The plurality of domains includes but not limited to, a healthcare domain, an insurance domain, a manufacturing domain, a contact center and a retail domain. Further, a plurality of document parameters comprising a heading, a sub-heading and a paragraph are extracted based on the plurality of unstructured documents associated with each of the plurality of domains using a document processing technique. Further, a schema is generated for each of the plurality of unstructured documents associated with each of the plurality of domains based on an associated plurality of document parameters. In an embodiment, parsing rules are used to ensure that all applicable documents metadata are captured despite inconsistencies in formatting. For example, the parsing rules includes scanning all available files, extract metadata which includes heading, subheading, ensure de-duplication of heading and subheading, prioritize role where similar text exists between heading and subheading.

Furthermore, an aggregated schema layout is generated for each of the plurality of domains by performing a union of a plurality of schemas associated with the plurality of unstructured documents associated with each of the plurality of domains and by assigning appropriate roles. Finally, the domain based master layout is generated for each of the plurality of domains based on an associated aggregated schema layout using a semantic preamble refined text generation technique, wherein the semantic preamble refined text generation technique replaces ambiguous document content with meaningful content.

For example, the semantic preamble refined text generation technique is explained as follows: for each original text, a call is made to Large Language Model with few-shot examples to get semantic preamble text conveying more meaningful text.

Referring back to FIG. 2, at step 208 of the method 200 the one or more hardware processors 102 is configured by the programmed instructions to extract a plurality of text contents from each of the plurality of unstructured input documents using the document processing technique, wherein the plurality of text contents comprises a heading, a subheading and a paragraph.

At step 210 of the method 200, the one or more hardware processors 102 is configured by the programmed instructions to generate a plurality of data frames based on a comparison between the plurality of text contents extracted from the plurality of input documents and the schema in the associated domain based master layout.

At step 212 of the method 200, the one or more hardware processors 102 is configured by the programmed instructions to generate a refined plurality of data frames by replacing a plurality of ambiguous text contents based on the schema in the associated domain based master layout. For example, if the original text/ambiguous text is “Inpatient care”, the semantic preamble text or refined plurality of data frames be “This section outlines critical guidelines for Inpatient care”.

At step 214 of the method 200, the one or more hardware processors 102 is configured by the programmed instructions to generate a plurality of data chunks based on the refined plurality of data frames.

At step 216 of the method 200, the one or more hardware processors 102 is configured by the programmed instructions to generate an associated vector embedding corresponding to each of the plurality of data chunks using a machine learning technique. For example, the machine learning technique used is embedding models which generates real floating numbers also known as vectors for each chunk in a way that it maintains semantic meaning of data chunks in the form of vectors.

At step 218 of the method 200, the one or more hardware processors 102 is configured by the programmed instructions to generate a response corresponding to the user request based on the generated associated vector embedding using an Large Language Model (LLM). For example, for the user input query, “What is policy to return damaged mobile?”, the response generated by LLM is given below:
You must report any damage to your mobile phone within 7 days of delivery.
We offer free return shipping for damaged phones.
The phone should be returned in its original packaging with all accessories.
Once we receive the damaged phone, we will send out a replacement immediately, often within 3-5 business days.
To report the damage, you can log in to your account on our website or mobile app. Navigate to the “Order History” section, select the damaged item, and click on “Report an Issue.”
If you need assistance, our customer service team is available via chat or phone to help guide you through the process.

In an embodiment, the overall flow diagram of the present disclosure is shown in FIG. 4. Now referring to FIG. 4, it describes a process of extracting, processing, and storing text data based on specific parameters and layouts. The process involves selecting a CSV (master layout) layout file, loading it into a DataFrame, filtering it based on the text and parameters, identifying the role of each paragraph as a title or a subtitle, refining and merging the titles and subtitles with the content, appending the content to a JSON dictionary, processing the content in chunks, and saving the data to the database.

Experimentation: The overall solution was tested for different industries and different products consisting of 50+unstructured documents where it was observed inconsistency across the documents. In the testing process, separate master layout files which capture schema of an unstructured file as described in FIG. 3 were created and then semantic preamble solution process was performed as described in FIG. 4. The experimentation result showed significantly improved consistency in terms of mapping heading and subheading to right domain contents which helps for efficient retrieval of domain content when passed to Large Language Model.

It was observed that the integration of the preamble semantic solution into the data ingestion process, coupled with the implementation of multi-vector search, led to significant improvements in our results. Furthermore, it was observed that more than 40% increase in result accuracy when compared to the approach that did not utilize the preamble.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of the present disclosure herein address the unresolved problem of optimal navigation of unstructured data for large language models. The present disclosure provides a optimal navigation of unstructured data. Further, the present disclosure can be scaled up to any number of domains that require information extraction and structuring from documents that have a consistent layout but are not well structured. Some examples of such domains are:
Travel insurance: The present disclosure can help travel insurance agents to quickly and accurately answer customer queries by extracting information from policy documents that contain different sections like Travel Interruptions, Travel Cancellation, FAQs etc. Our solution can map the right headings and subheadings to the right paragraphs and provide relevant answers or suggestions to the agents. This can enhance customer experience and operational efficiency.
Contact center: The present disclosure can help contact center agents to efficiently and effectively respond to customer queries by extracting information from FAQs or transcript files that contain customer questions and answers. Our solution can identify the key topics and subtopics in the files and provide relevant answers or suggestions to the agents. This can improve customer satisfaction and agent productivity.
Manufacturing: The present disclosure can help customers or manufacturers to easily and reliably access information from operational or user documents that are not well structured and extracting metadata is very difficult. Our solution can extract metadata information from product documents that contain specifications, instructions, warranties, or troubleshooting guides, and provide relevant answers or suggestions to the users. This can increase customer loyalty and reduce costs and risks for the manufacturers.

It is to be understood that the scope of the protection is extended to such a program and in addition to a computer-readable means having a message therein such computer-readable storage means contain program-code means for implementation of one or more steps of the method when the program runs on a server or mobile device or any suitable programmable device. The hardware device can be any kind of device which can be programmed including e.g., any kind of computer like a server or a personal computer, or the like, or any combination thereof. The device may also include means which could be e.g., hardware means like e.g., an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means, and software means. The method embodiments described herein could be implemented in hardware and software. The device may also include software means. Alternatively, the embodiments may be implemented on different hardware devices, e.g., using a plurality of CPUs, GPUs and edge computing devices.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise. Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e. non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

We claim:

1. A processor-implemented method, the method comprising:
receiving, via one or more hardware processors, a user request and an associated plurality of unstructured input documents, wherein the user request is in natural language;
extracting, via the one or more hardware processors, a plurality of request parameters based on the user request, wherein the request parameters comprises an industry name, a product name and domain contents;
obtaining, via the one or more hardware processors, a master layout from among a plurality of domain based master layouts based on the plurality of request parameters, wherein the master layout comprises a schema and a plurality of document structure details, wherein each of the plurality of domain based master layout is generated by:
receiving a plurality of unstructured documents associated with each of a plurality of domains, wherein the plurality of domains comprises a healthcare domain, an insurance domain, a manufacturing domain, a contact center and a retail domain;
extracting a plurality of document parameters comprising a heading, a sub heading and a paragraph based on the plurality of unstructured documents associated with each of the plurality of domains using a document processing technique;
generating a schema for each of the plurality of unstructured documents associated with each of the plurality of domains based on an associated plurality of document parameters;
generating an aggregated schema layout for each of the plurality of domains by performing a union of a plurality of schemas associated with the plurality of unstructured documents associated with each of the plurality of domains and by assigning appropriate roles; and
generating the domain based master layout for each of the plurality of domains based on an associated aggregated schema layout using a semantic preamble refined text generation technique, wherein the semantic preamble refined text generation technique replaces ambiguous text content with meaningful content.
extracting, via the one or more hardware processors, a plurality of text contents from each of the plurality of unstructured input documents using the document processing technique, wherein the plurality of text contents comprises a heading, a subheading and a paragraph;
generating, via the one or more hardware processors, a plurality of data frames based on a comparison between the plurality of text contents extracted from the plurality of input documents and the schema in the associated master layout;
generating, via the one or more hardware processors, a refined plurality of data frames by replacing a plurality of ambiguous text contents based on the schema in the associated domain based master layout;
generating, via the one or more hardware processors, a plurality of data chunks based on the refined plurality of data frames;
generating, via the one or more hardware processors, an associated vector embedding corresponding to each of the plurality of data chunks using a machine learning technique; and
generating, via the one or more hardware processors, a response corresponding to the user request based on the generated associated vector embedding using a Large Language Model (LLM).

2. The method of claim 1, wherein the plurality of unstructured input documents comprises a plurality of entities.

3. The method of claim 1, wherein the aggregated schema layout comprises a metadata associated with each section corresponding to each of the plurality of unstructured documents associated with each of the plurality of domains, wherein the metadata comprises refined text, the assigned role, heading and subheading name, and the parent-child relationship between headings and subheadings.

4. The method of claim 1, wherein the meaningful content is a content that helps LLM to understand context in a better way and to effectively respond to user question and thereby mitigating ambiguity.

5. A system comprising:
at least one memory storing programmed instructions; one or more Input/Output (I/O) interfaces; and one or more hardware processors operatively coupled to the at least one memory, wherein the one or more hardware processors are configured by the programmed instructions to:
receive a user request and an associated plurality of unstructured input documents, wherein the user request is in natural language;
extract a plurality of request parameters based on the user request, wherein the request parameters comprises an industry name, a product name and domain contents;
obtain a master layout from among a plurality of domain based master layouts based on the plurality of request parameters, wherein the master layout comprises a schema and a plurality of document structure details, wherein each of the plurality of domain based master layout is generated by:
receiving a plurality of unstructured documents associated with each of a plurality of domains, wherein the plurality of domains comprises a healthcare domain, an insurance domain, a manufacturing domain, a contact center and a retail domain;
extracting a plurality of document parameters comprising a heading, a sub heading and a paragraph based on the plurality of unstructured documents associated with each of the plurality of domains using a document processing technique;
generating a schema for each of the plurality of unstructured documents associated with each of the plurality of domains based on an associated plurality of document parameters;
generating an aggregated schema layout for each of the plurality of domains by performing a union of a plurality of schemas associated with the plurality of unstructured documents associated with each of the plurality of domains and by assigning appropriate roles; and
generating the domain based master layout for each of the plurality of domains based on an associated aggregated schema layout using a semantic preamble refined text generation technique, wherein the semantic preamble refined text generation technique replaces ambiguous text content with meaningful content.
extract a plurality of text contents from each of the plurality of unstructured input documents using the document processing technique, wherein the plurality of text contents comprises a heading, a subheading and a paragraph;
generate a plurality of data frames based on a comparison between the plurality of text contents extracted from the plurality of input documents and the schema in the associated master layout;
generate a refined plurality of data frames by replacing a plurality of ambiguous text contents based on the schema in the associated domain based master layout;
generate a plurality of data chunks based on the refined plurality of data frames;
generate an associated vector embedding corresponding to each of the plurality of data chunks using a machine learning technique; and
generate a response corresponding to the user request based on the generated associated vector embedding using a Large Language Model (LLM).

6. The system of claim 5, wherein the plurality of unstructured input documents comprises a plurality of entities.

7. The system of claim 5, wherein the aggregated schema layout comprises a metadata associated with each section corresponding to each of the plurality of unstructured documents associated with each of the plurality of domains, wherein the metadata comprises refined text, the assigned role, heading and subheading name, and the parent-child relationship between headings and subheadings.

8. The system of claim 5, wherein the meaningful content is a content that helps LLM to understand context in a better way and to effectively respond to user question and thereby mitigating ambiguity.

9. One or more non-transitory machine-readable information storage mediums comprising one or more instructions which when executed by one or more hardware processors cause:
receiving a user request and an associated plurality of unstructured input documents, wherein the user request is in natural language;
extracting a plurality of request parameters based on the user request, wherein the request parameters comprises an industry name, a product name and domain contents;
obtaining a master layout from among a plurality of domain based master layouts based on the plurality of request parameters, wherein the master layout comprises a schema and a plurality of document structure details, wherein each of the plurality of domain based master layout is generated by:
receiving a plurality of unstructured documents associated with each of a plurality of domains, wherein the plurality of domains comprises a healthcare domain, an insurance domain, a manufacturing domain, a contact center and a retail domain;
extracting a plurality of document parameters comprising a heading, a sub heading and a paragraph based on the plurality of unstructured documents associated with each of the plurality of domains using a document processing technique;
generating a schema for each of the plurality of unstructured documents associated with each of the plurality of domains based on an associated plurality of document parameters;
generating an aggregated schema layout for each of the plurality of domains by performing a union of a plurality of schemas associated with the plurality of unstructured documents associated with each of the plurality of domains and by assigning appropriate roles; and
generating the domain based master layout for each of the plurality of domains based on an associated aggregated schema layout using a semantic preamble refined text generation technique, wherein the semantic preamble refined text generation technique replaces ambiguous text content with meaningful content.
extracting a plurality of text contents from each of the plurality of unstructured input documents using the document processing technique, wherein the plurality of text contents comprises a heading, a subheading and a paragraph;
generating a plurality of data frames based on a comparison between the plurality of text contents extracted from the plurality of input documents and the schema in the associated master layout;
generating a refined plurality of data frames by replacing a plurality of ambiguous text contents based on the schema in the associated domain based master layout;
generating a plurality of data chunks based on the refined plurality of data frames;
generating an associated vector embedding corresponding to each of the plurality of data chunks using a machine learning technique; and
generating a response corresponding to the user request based on the generated associated vector embedding using a Large Language Model (LLM).

10. The one or more non-transitory machine-readable information storage mediums of claim 9, wherein the plurality of unstructured input documents comprises a plurality of entities.

11. The one or more non-transitory machine-readable information storage mediums of claim 9, wherein the aggregated schema layout comprises a metadata associated with each section corresponding to each of the plurality of unstructured documents associated with each of the plurality of domains, wherein the metadata comprises refined text, the assigned role, heading and subheading name, and the parent-child relationship between headings and subheadings.

12. The one or more non-transitory machine-readable information storage mediums of claim 9, wherein the meaningful content is a content that helps LLM to understand context in a better way and to effectively respond to user question and thereby mitigating ambiguity.
